(19) United States
(12) Patent Application Publication
(10) Pub. No.: US 2004/0090773 A1
(43) Pub. Date: May 13, 2004

(54) Adaptable electric accessory system for containers, receptacles, and the like

(76) Inventor: Jimmy H. Bryan, Houston, TX (US)

Correspondence Address: LEONARD & PROEHL, PROF. L.L.C., 3500 SOUTH FIRST AVENUE CIRCLE, SUITE 250, SIOUX FALLS, SD, 57105, US

(21) Appl. No.: 10/694,105

(22) Filed: Oct. 27, 2003

Related U.S. Application Data
(63) Continuation-in-part of application No. 10/050,977, filed on Jan. 18, 2002, now Pat. No. 6,637,909.
Application No. 10/050,977 is a continuation-in-part of application No. 09/460,368, filed on Dec. 13, 1999, now Pat. No. 6,340,235.
Application No. 09/460,368 is a continuation-in-part of application No. 09/005,655, filed on Jan. 12, 1998, now abandoned.

(51) Int. Cl. F21V 33/00; F21L 13/00

(52) U.S. Cl. 362/156; 362/155; 362/86; 362/183

(57) ABSTRACT

A receptacle system is disclosed for powering an electronic device. The system comprises a receptacle having an interior compartment, interfacing apparatus for interfacing with the electronic device, processing apparatus on the receptacle for processing signals from the electronic device received through the interfacing apparatus , and powering apparatus mounted on the receptacle for powering the electronic device.

### CROSS REFERENCE TO RELATED APPLICATION

The present application is a continuation-in-part of application 10/050,977, filed Jan. 18, 2002, which was a continuation-in-part of an application filed Dec. 13, 1999, and assigned the application number 09/460,368, which was a continuation-in-part of an application filed Jan. 12, 1998, and assigned the application number 09/005,655, which is incorporated herein by reference.

### BACKGROUND OF THE INVENTION

1. Field of the Invention

The present invention relates to a new adaptable electric accessory system for containers, receptacles, and the like for powering electronic devices situated in or on the receptacle.

2. Description of the Prior Art

The use of illuminated containers is known in the prior art. More specifically, illuminated containers heretofore devised and utilized are known to consist basically of familiar, expected and obvious structural configurations, notwithstanding the myriad of designs encompassed by the crowded prior art which have been developed for the fulfillment of countless objectives and requirements.

Known prior art includes U. S. Pat. No. 4,912,611; U.S. Pat. No. 4,972,304; U.S. Pat. Des. 315,830; U.S. Pat. No. 4,263,951; U.S. Pat. No. 5,207,254; and U.S. Pat. No. 3,976,871 which are all incorporated herein by reference.

In these respects, the adaptable electric accessory system for containers, receptacles, and the like according to the present invention substantially departs from the conventional concepts and designs of the prior art, and in so doing provides an apparatus primarily developed for the purpose of powering electronic devices situated therein, or attached thereto, with a rechargeable onboard battery or batteries as well as recharge the batteries of removable electric devices.

### SUMMARY OF THE INVENTION

In view of the disadvantages inherent in the known types of containers now present in the prior art, the present invention provides a new adaptable electric accessory system for containers, receptacles, and the like wherein the same can be utilized for illuminating a receptacle and powering electronic devices situated therein, or attached thereto, with a rechargeable onboard battery or batteries as well as recharge the batteries of removable electric devices.

The general purpose of the present invention, which will be described subsequently in greater detail, is to provide a new adaptable electric accessory system for containers, receptacles, and the like which has many of the advantages of the illuminated containers mentioned heretofore and many novel features that result in a new adaptable electric accessory system for containers, receptacles, and the like which is not anticipated, rendered obvious, suggested, or even implied by any of the prior art illuminated containers, either alone or in any combination thereof.

To attain this, the present invention generally comprises a receptacle system for powering an electronic device. The system comprises a receptacle having an interior compartment, interfacing apparatus for interfacing with the electronic device, processing apparatus on the receptacle for processing signals from the electronic device received through the interfacing apparatus, and powering apparatus mounted on the receptacle for powering the electronic device.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new adaptable electric accessory system for containers, receptacles, and the like which has many of the advantages of the containers mentioned heretofore and many novel features that result in a new adaptable electric accessory system for containers, receptacles, and the like which is not anticipated, rendered obvious, suggested, or even implied by any of the prior art containers, either alone or in any combination thereof.

It is another object of the present invention to provide a new adaptable electric accessory system for containers, receptacles, and the like which may be easily and efficiently manufactured and marketed.

It is a further object of the present invention to provide a new adaptable electric accessory system for containers, receptacles, and the like which is of a durable and reliable construction.

An even further object of the present invention is to provide a new adaptable electric accessory system for containers, receptacles, and the like which is susceptible of a low cost of manufacture with regard to both materials and labor, and which accordingly is then susceptible of low prices of sale to the consuming public, thereby making such adaptable electric accessory system for containers, receptacles, and the like economically available to the buying public.

Still yet another object of the present invention is to provide a new adaptable electric accessory system for containers, receptacles, and the like which provides in the apparatuses and methods of the prior art some of the advantages thereof, while simultaneously overcoming some of the disadvantages normally associated therewith.

Still another object of the present invention is to provide a new adaptable electric accessory system for containers, receptacles, and the like for powering electronic devices situated therein or thereon via a rechargeable onboard battery.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic upper perspective view of a new adaptable electric accessory system according to the present invention.

FIG. 2 is a schematic sectional view taken along line 2-2 of FIG. 1.

FIG. 3 is a schematic exploded upper perspective view of the present invention.

FIG. 4 is a schematic sectional view taken along line 4-4 of FIG. 3.

FIG. 5 is a schematic diagram of the preferred circuitry of the present invention.

FIG. 6 is a schematic exploded upper perspective view of an alternative embodiment of the present invention.

FIG. 7 is a schematic sectional view taken along line 7-7 of FIG. 6 of the alternative embodiment.

FIG. 8 is a schematic perspective view of a charging base for the retainer device of the present invention.

FIG. 9 is a schematic front perspective view of an optional adaptable electric accessory system for containers, receptacles, and the like according to the present invention.

FIG. 10 is a schematic front perspective view of the insert of the present invention removed from the receptacle.

FIG. 11 is a schematic perspective view of the present invention with the flaps of the insert and the receptacle in an open orientation.

FIG. 12 is a schematic top view of the insert showing the fiber optic liner panels thereof.

FIG. 13 is a schematic front view of the frame of the receptacle of the present invention.

FIG. 13A is a schematic side view of a portion of an optional forcible release assembly of the present invention.

FIG. 14 is a schematic diagram of the electrical interrelationships of the electrical components of one embodiment of the charging base of the present invention.

FIG. 15 is a schematic diagram of the electrical assembly of the receptacle of the present invention.

FIG. 16 is a schematic diagram of a timer mechanism of the insert of the present invention.

FIG. 17 is a schematic perspective view of the exterior of another optional embodiment of the present invention.

FIG. 18 is a schematic perspective view of the insert portion of the optional embodiment of FIG. 9.

FIG. 19 is a schematic perspective view of the optional embodiment of FIG. 9 with the lid raised to particularly illustrate the insert located in the receptacle of the present invention.

FIG. 20 is a schematic perspective phantom view of the insert of the present invention particularly illustrating circuitry of the insert.

FIG. 21 is a schematic perspective phantom view of the receptacle of the present invention particularly illustrating circuitry and internal walls of the receptacle.

FIG. 22 is a schematic bottom view of the receptacle of the invention particularly illustrating the features of the bottom of the receptacle.

FIG. 23 is a schematic perspective view of an optional embodiment of a charging base of the present invention.

FIG. 24 is a schematic perspective view of the receptacle rested on the charging base for charging the battery.

FIG. 25 is a schematic diagram of the electrical interrelationships of the components of the receptacle and the insert of the optional embodiment.

FIG. 26 is a schematic view of a portion of an optional forcible release assembly.

FIG. 27 is a schematic view of a portion of an optional forcible release assembly.

FIG. 28 is a schematic sectional view of a portion of the optional forcible release assemblies shown in FIGS. 26 and 17.

FIG. 29 is a schematic view of a portion of an optional forcible release assembly.

FIG. 30 is a schematic perspective view of one embodiment of the present invention having portions removed to reveal detail of the interior compartment of the receptacle.

FIG. 31 is a schematic bottom view of the receptacle of the embodiment shown in FIG. 30.

FIG. 32 is a schematic diagrammatic view of the circuitry of one embodiment of the present invention.

FIG. 33 is a schematic exploded perspective view of the circuitry case of one embodiment of the present invention.

FIG. 34 is a schematic perspective view of the circuitry case, illumination apparatus, power adapter connector, and switch of one embodiment of the present invention.

FIG. 35 is a schematic front view of one of the illumination assemblies of one embodiment of the invention.

FIG. 36 is a schematic diagrammatic representation of another embodiment of the present invention.

### DESCRIPTION OF THE PREFERRED EMBODIMENT

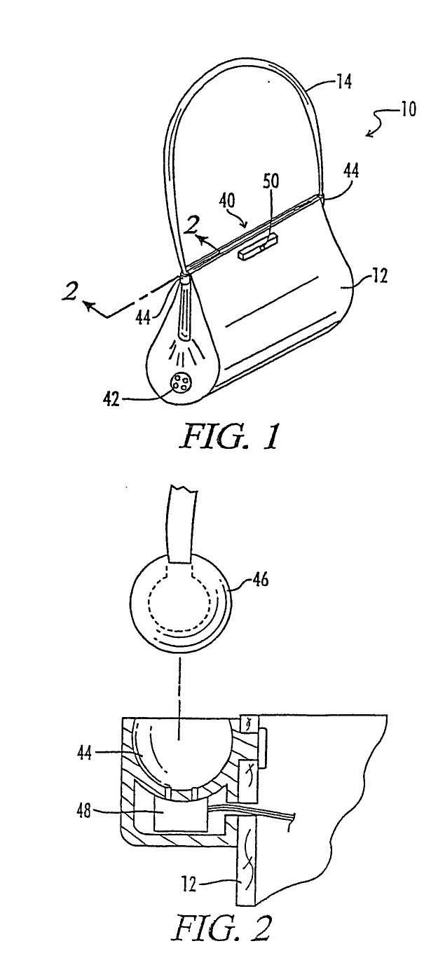

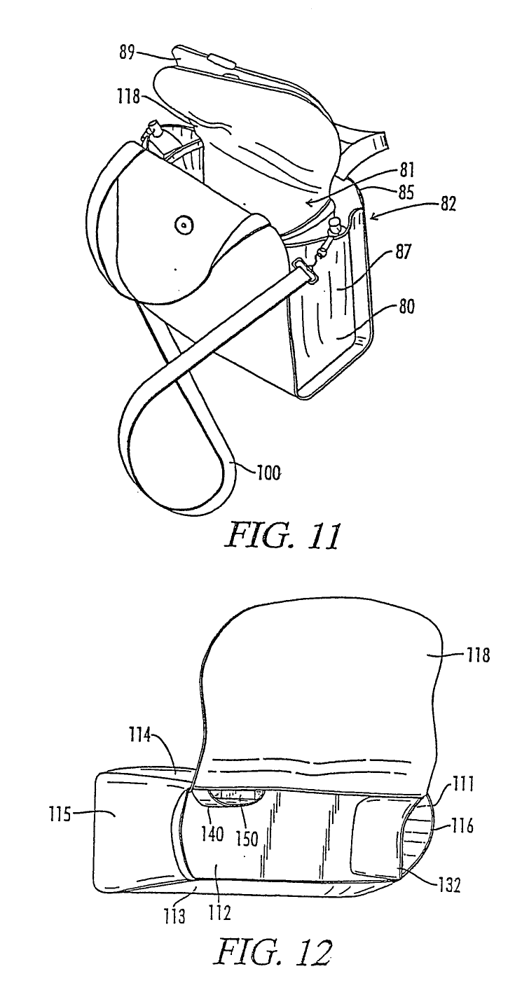

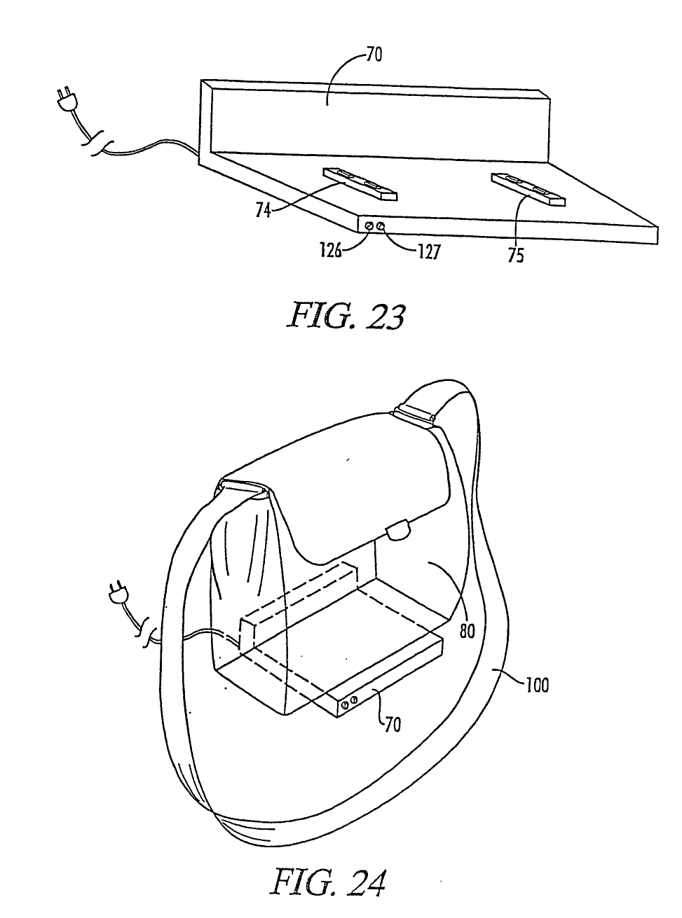

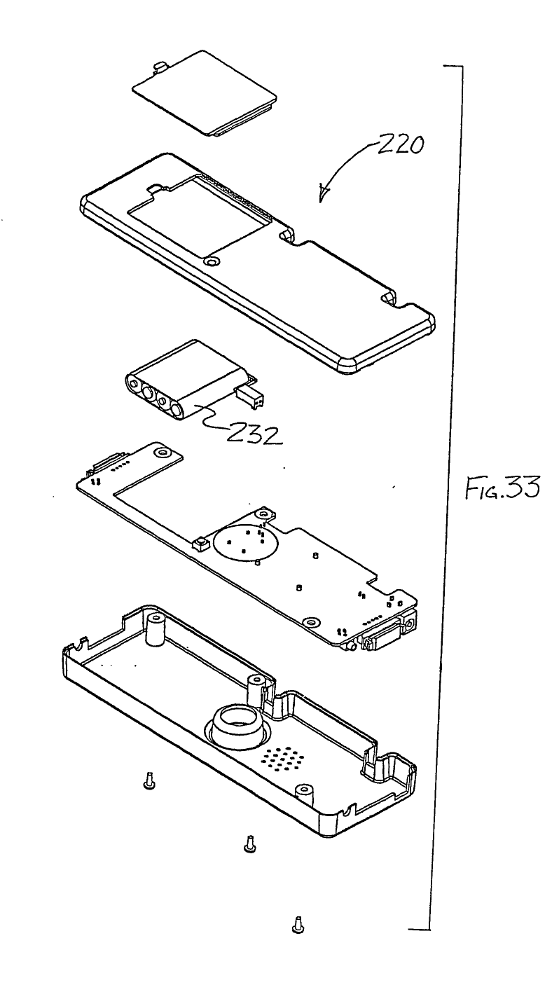

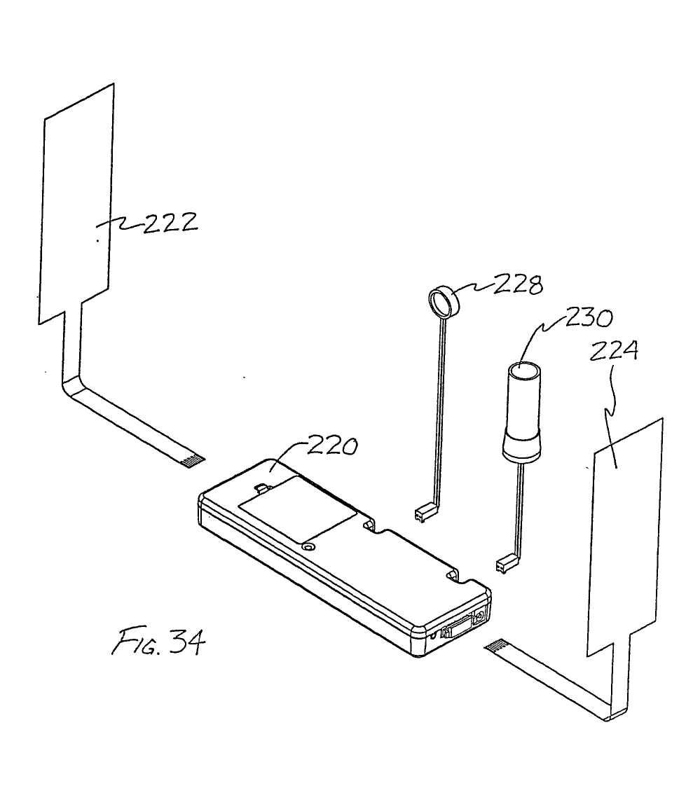

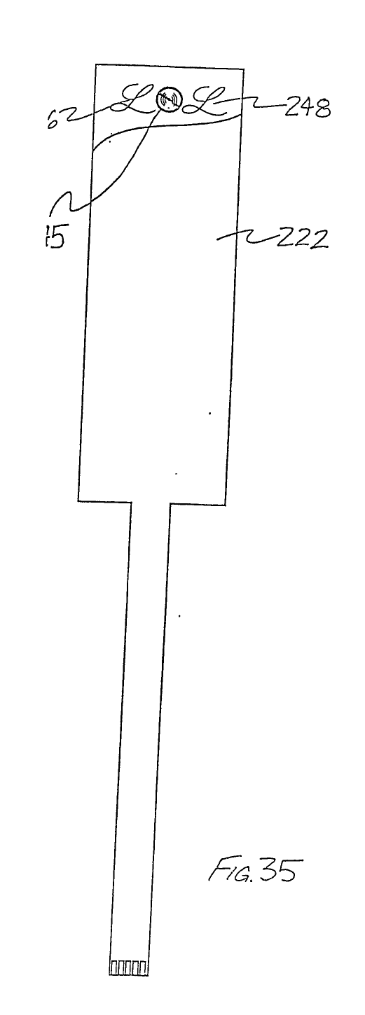

With reference now to the drawings, and in particular to FIGS. 1 through 36 thereof, a new adaptable electric accessory system for containers, receptacles, and the like embodying the principles and concepts of the present invention and generally designated by the reference numeral 10 will be described.

With particular reference to FIGS. 1 through 8, it will be noted that the invention 10 comprises a retainer device 12 adapted to receive a removable liner 20 which is removably positionable within an interior compartment of the retainer device 12 for permitting transfer of the liner 20 between a variety of retainer devices (having, for example, different fashion styles). An illustrative and preferred retainer device is a handbag or purse having a shoulder strap 14 for positioning on the shoulder of a user to support the handbag in a location adjacent to the body of the user. An illustrative handbag is elongated in one direction to form a somewhat pocket-like enclosure with an elongate opening 18. The shape of the handbag may vary due to the flexible nature of the preferred material forming the handbag, and therefore a multitude of shapes may be useful.

A securing means for releasably holding the liner 20 in the interior of the retainer device 12 is preferably provided, and one illustrative means for holding the liner 20 in a position within the handbag retainer device 12 is a zipper having one set 16 of cooperating zipper teeth mounted on the exterior of the liner and the other set 17 of cooperative zipper teeth on the interior of the retainer device.

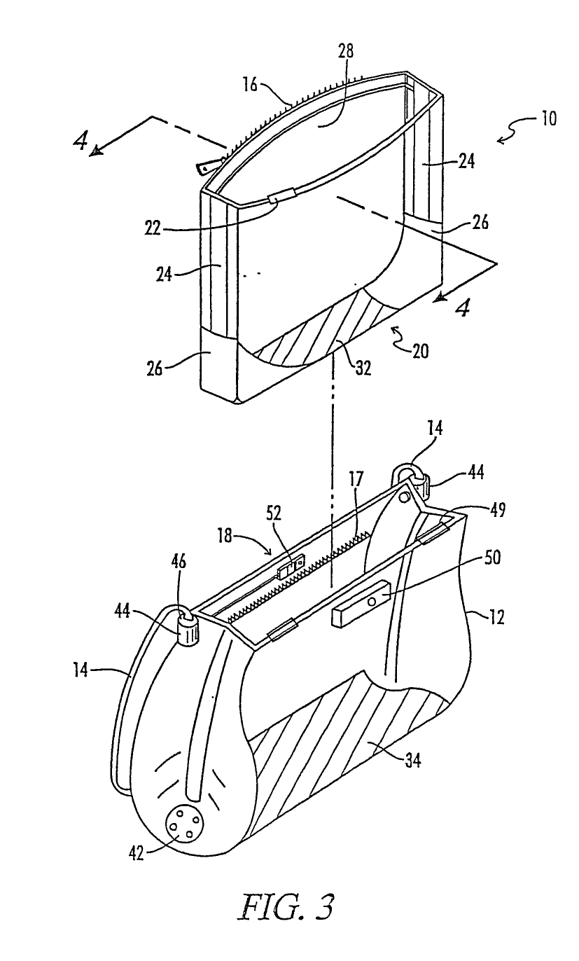

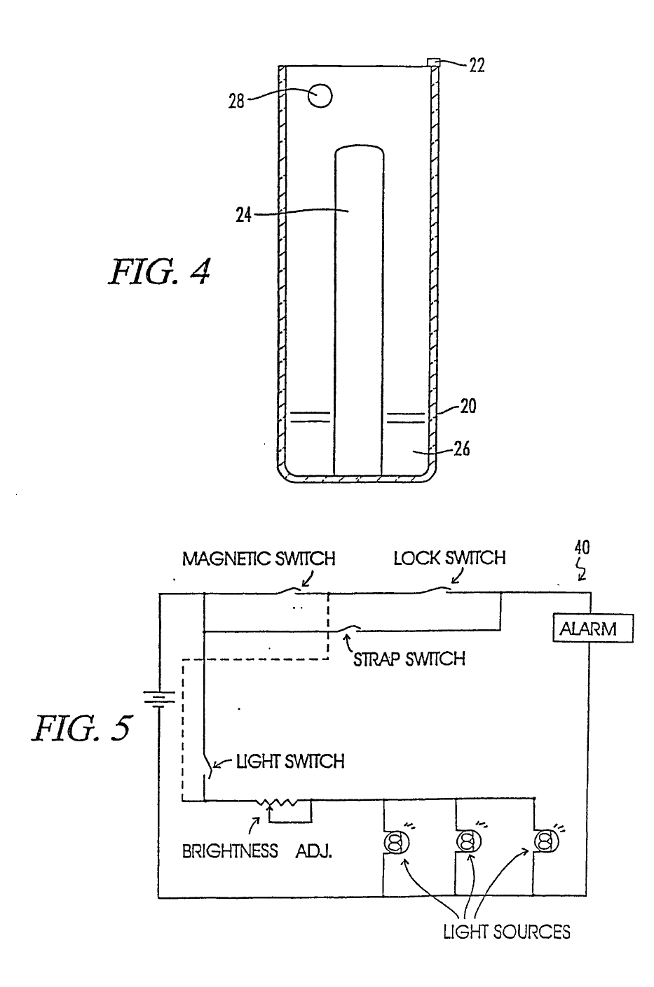

At least one light source 26 is secured on the liner 20 for illuminating objects held within the liner 20 (as shown in FIGS. 3 and 4). The liner 20 is most preferably constructed from a light emitting fabric 28 which distributes light from the light source to substantially all parts of the liner 20. The light emitting fabric 28 is comprised of a plurality of fiber optic cables or fibers or filaments woven together and optically connected to the light source 26 for emitting light uniformly throughout the liner 20.

The preferred light source 26 for illuminating the fiber optic filaments forming the liner 20 is a laser-based light source 26 and a light reflection/conduction tube 24. Most preferably, a laser light source 26 and a light reflection/conduction tube 24 are located at each longitudinal end of the handbag retainer device 12. The laser light source 26 is preferably located at a lower corner location in the interior of the liner 20, and the light reflection/conduction tube 24 extends upwardly from the laser light source 26 along the longitudinal end of the liner compartment. The laser light source 26 is in optical communication with the reflection/conduction tube 24, and in turn the reflection/conduction tube is in optical communication with the ends of the woven fiber optic filaments of the material forming the liner 20.

The light source 26 is preferably electrically connected to a power source 32 carried on the liner 20. The preferable power source is a rechargeable battery strip 32 located at the base of the liner 20, and which is recharged by any suitable conventional means.

As shown in FIGS. 3 and 4 of the drawings, a combination power switch and dimmer control 22 is secured to the liner 20 and is electrically connected between the light source 26 and the power source 32 to vary the electrical power supplied to the light source 26.

As shown in FIGS. 2 and 5, an alarm system 40 is secured within the handbag retainer device 12 for detecting when a strap 14 secured to the handbag retainer device 12 is disconnected from the handbag (such as by another individual during a theft). The alarm system 40 includes a pair of strap end receiving sockets 44 located at the longitudinal ends of the receiver device 12, and each socket 44 receives a spherical ball 46 secured to each of the opposite ends of the strap 14. Each spherical ball 46 is held in a strap end receiving socket 44 by an interference-type fit such that only a strong pull on the strap 14 (such as by a thief forcibly removing the handbag receiver device from the wearer of the handbag) is able to remove the ball 46 from the socket 44. An electrical buzzer 42 is secured on the retainer device 12 and is electrically connected to the alarm system 40 such that the buzzer 42 emits an audible alarm automatically when the continuity of the circuit of the alarm system 40 is completed (by removing the ball 46 from the socket 44) at either of the strap switches 48 located within the strap end receiving sockets 44.

A magnetic lock is preferably secured on the retainer device 12 adjacent to the opening 18 for closing the retainer device 12. The magnetic lock has a first part 50 and a second part 52 which are magnetically linked. The parts 50, 52 are electrically connected to the alarm system 40 for activating the alarm system 40 and emitting an audible alarm when the retainer device 12 is opened without first deactivating the alarm system.

The power source 34 for the alarm system 40 is preferably carried in the retainer device 12. The preferred power source 34 is a rechargeable battery strip located at (and most preferably united to) the bottom of the interior compartment of the retainer device 12. In the most preferred embodiment of the invention, a recharging base 70 with contact posts 72 that are adapted to contact structures on the retainer device 12 which are in electrical communication with the positive and negative poles of the battery strip 34 in the retainer device 12 for recharging the battery when the device is placed on the recharging base 72.

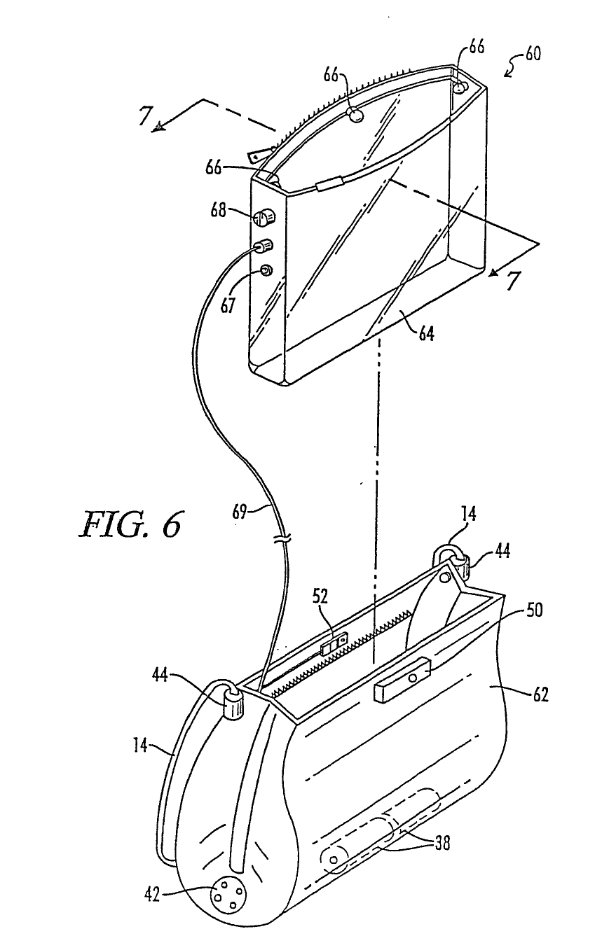

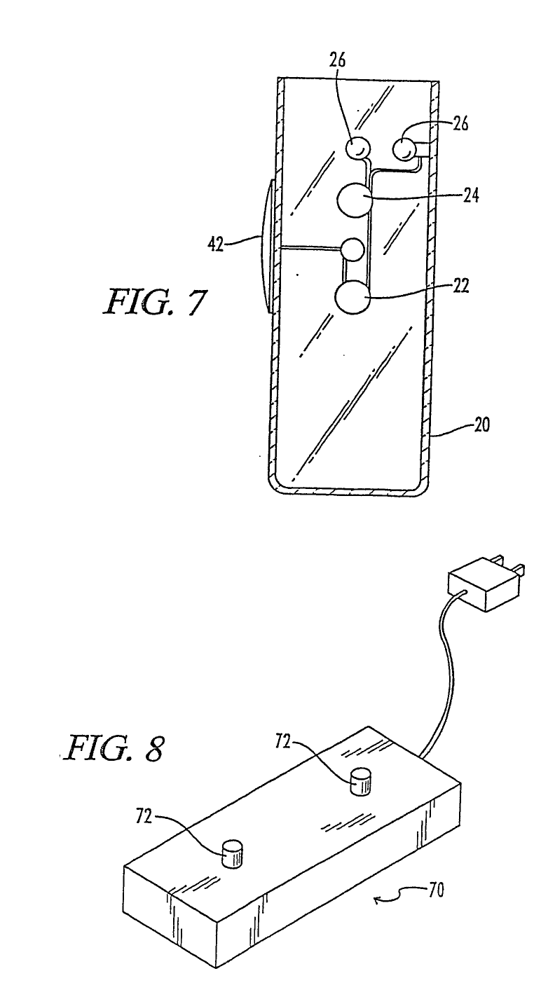

An optional embodiment 60 of the present invention is illustrated in FIGS. 6 and 7 of the drawings. The optional embodiment 60 employs a retainer device 62 similar to the construction of retainer device 12 shown in FIG. 3. A liner 64 is adapted to be removably positioned within the retainer device 62, and the liner 64 is most preferably formed of a transparent sheet material which permits a user to observe through the wall of the liner 64 the objects held within the liner 64.

A light source, which preferably comprises at least one light bulb 66, is mounted on the interior of the liner 64. A dimmer switch 68 is mounted on the liner 64 to vary the power supplied to the light bulb 66. A power switch 67 provides a means of turning the light bulb 66 on and off. An electrical cord 69 transfers power from replaceable batteries 38 carried in the retainer device 62 to the liner 60.

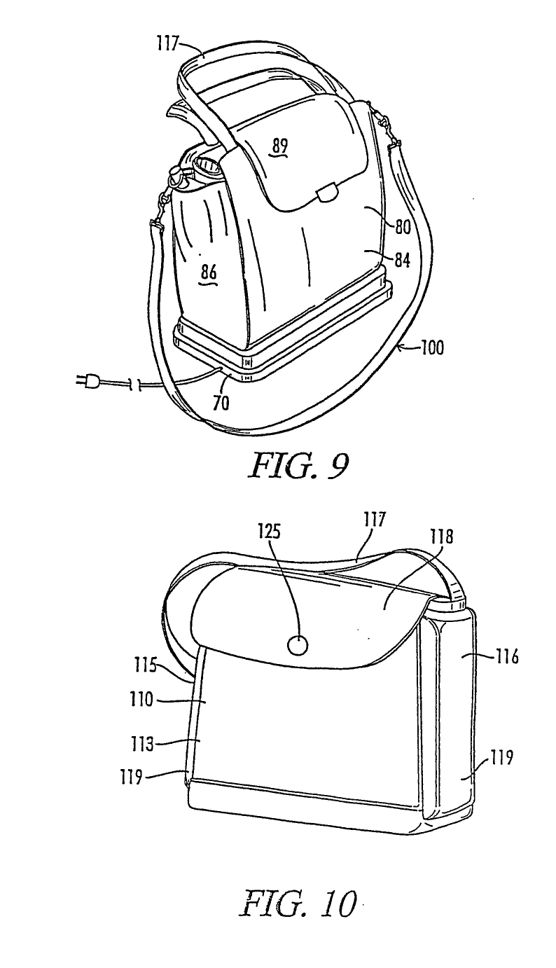

FIGS. 9 through 16 and FIGS. 17 through 19 disclose additional embodiments of the invention showing a number of features that may optionally be incorporated as shown or with other embodiments of the invention.

The system includes a receptacle 80 having an interior compartment 81. The receptacle has an outer housing 82 constructed from a flexible material and which includes a substantially rectangular bottom panel 83, a front panel 84 and a rear panel 85, and a pair of end panels 86, 87 connecting the front and rear panels. The front panel, the rear panel, and the end panels extend upwardly from the bottom panel, the front, rear and end panels to define an open top and an interior space. A flexible flap 89 may be integrally coupled to a top portion of the rear panel of the outer housing such that the flap may be positioned to cover the open top of the outer housing. The flap of the outer housing may be releasably secured in a covering position by a snap fastener, a zipper, hook and loop fasteners, and the like.

The receptacle 80 may be provided with a frame 90 to support the panels of the receptacle and engage the insert constructed from a substantially rigid material and including a bottom wall 91, which may have a substantially planar rectangular configuration. The bottom wall has relatively shorter ends and relatively longer sides. A pair of upstanding primary side walls 92, 93 may each have a bottom end coupled to one of a pair of short ends of the bottom wall. The primary side walls 92, 93 extend upwardly from the bottom wall. A pair of upstanding secondary side walls 94, 95 are also provided. Each of the secondary side walls have a lower extent coupled to the bottom end of one of the primary side walls. Each of the secondary side walls extend outwardly and upwardly from the bottom end of the corresponding primary side wall. Each of the secondary side walls has an upper extent extending upwardly in spaced parallel relationship with one of the primary side walls.

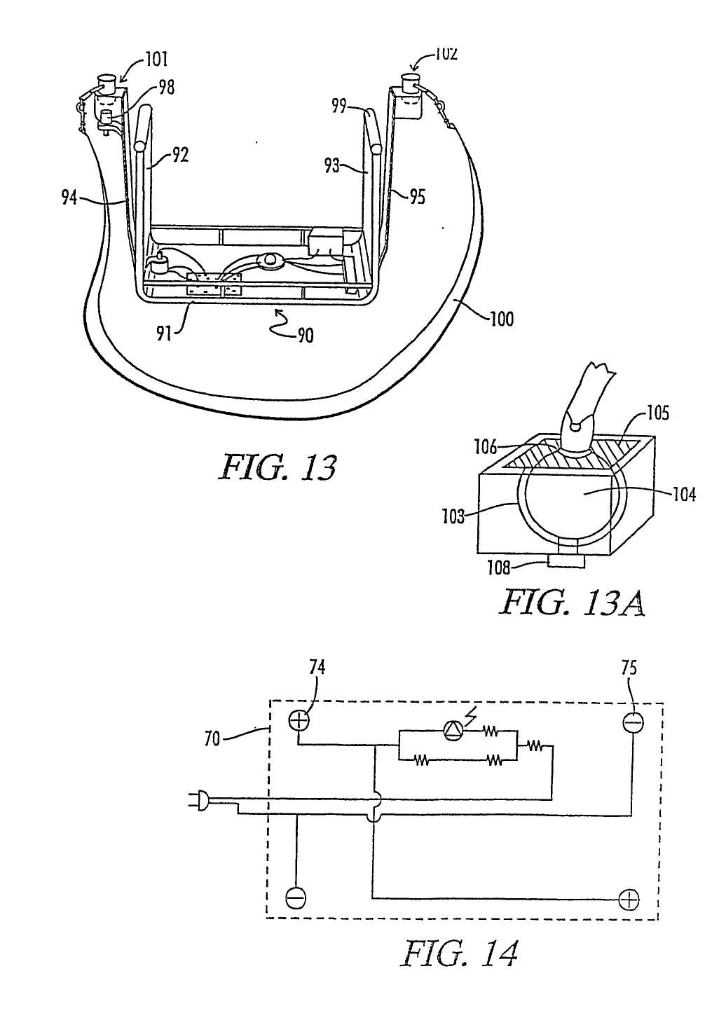

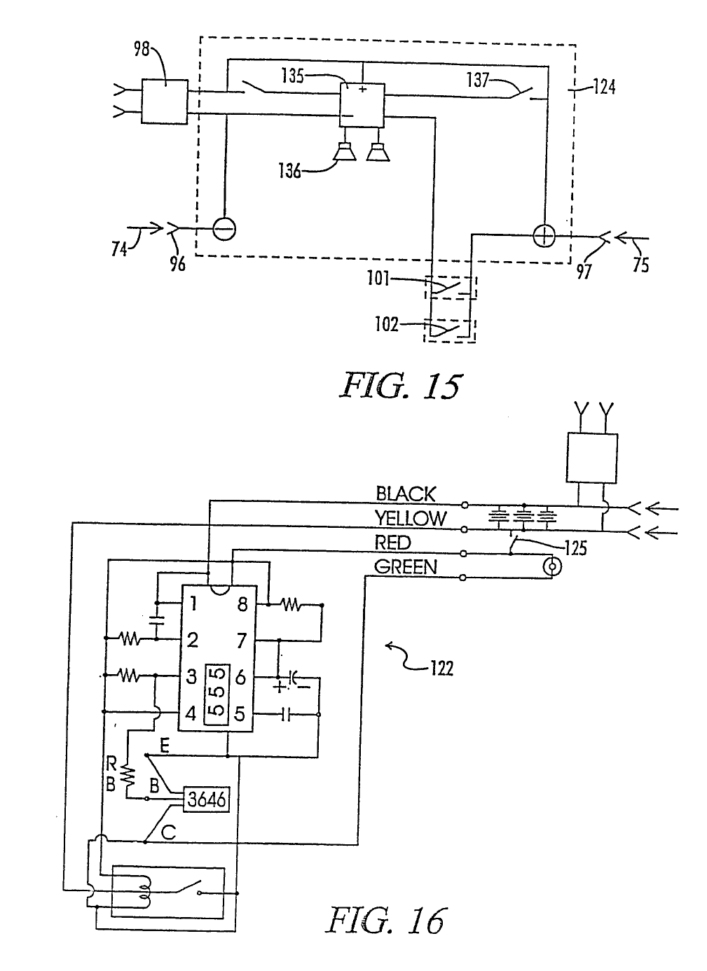

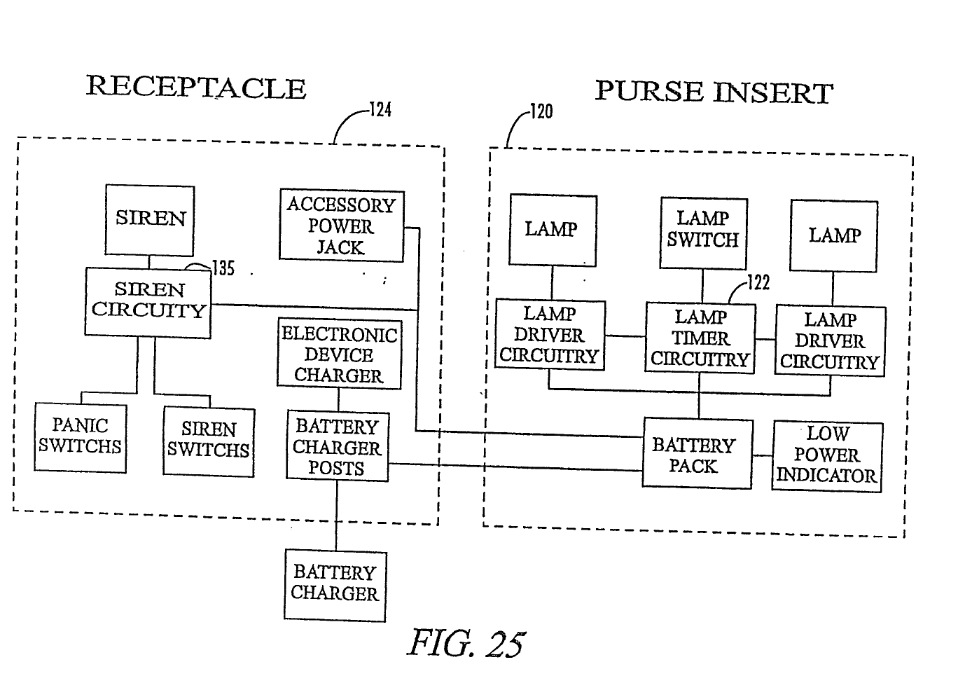

The receptacle preferably includes a receptacle electrical assembly. See FIGS. 15 and 25. The receptacle electrical assembly may include at least two first conductive contacts 96, 97 exposed through the bottom panel 83 of the outer housing such that placement of the outer housing of the receptacle on the charging base 70 brings the first conductive contacts into contact with the second conductive contacts 74, 75 of the charging base. A power adapter connector 98 may be mounted on the top end of one of the secondary side walls of the frame for being releasably connected to a connector of a portable electronic device. See FIG. 13. The receptacle electrical assembly may further include a pair of conductive sleeves contacts 99 positioned on top ends of the primary side walls.

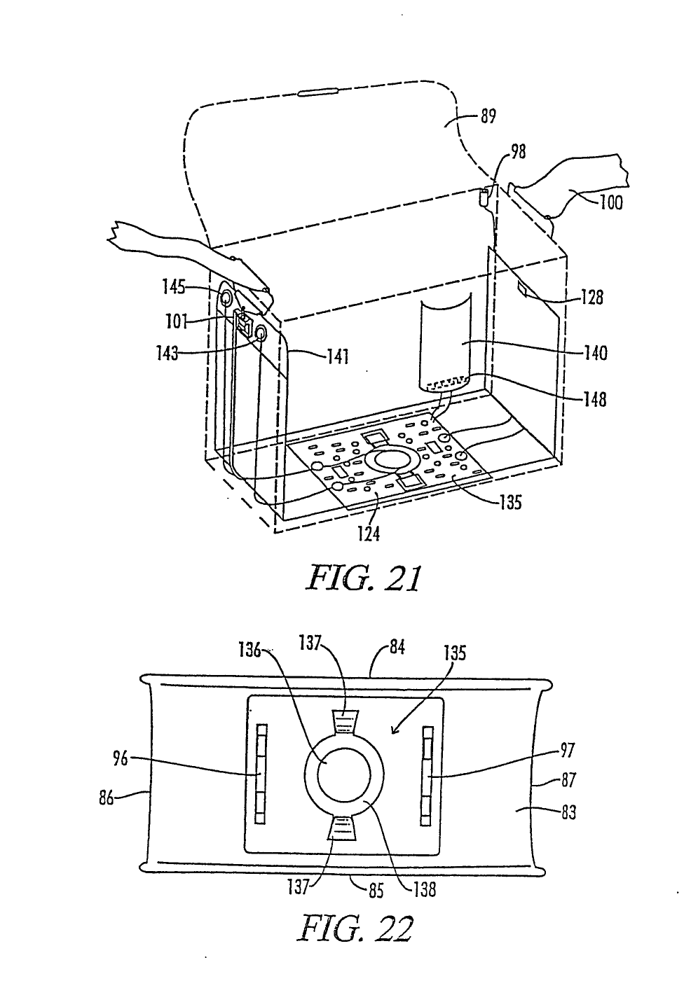

A handle assembly for the receptacle may comprise a flexible strap 100 having ends coupled to opposite end panels of the outer housing. A pair of forcible release assemblies 101, 102 may be provided for activating the alarm if the receptacle is forcibly taken away from the user. Each of the forcible release assemblies are connected to an opposite end of the strap 100 at the end panels of the receptacle. Each of the forcible release assemblies includes a socket connector 103 mounted to a top end of one of the end panels of the receptacle (see FIG. 21), or may be mounted to one of the secondary side walls of the frame (see FIG. 13). Each of the forcible release assemblies may include a ball connector 104 for releasably receiving the socket connector (see FIG. 13A). Each of the ball connectors has a lower extent with a substantially spherical configuration received in one of the socket connectors. The ball connector has an upper extent with a loop connected to one of the ends of the strap 100. The forcible release assembly further comprises a retainer plate 105 for closing a chamber in the socket connector receiving the ball connector. The retainer plate has an opening 106 that permits the strap connecting loop of the upper extent of the ball connector to pass through the retainer plate. The retainer plate is adapted to release the ball connector from the socket connector upon the application of a significant pulling force on the strap and the strap connecting loop of the ball connector. The forcible release assembly further comprises a pair of alarm switches 108, with each of the alarm switches being situated in the chamber of one of the socket connectors of the handle assembly for transmitting an alarm triggering signal upon the disconnection of either one of the ball connectors from the respective socket connector.

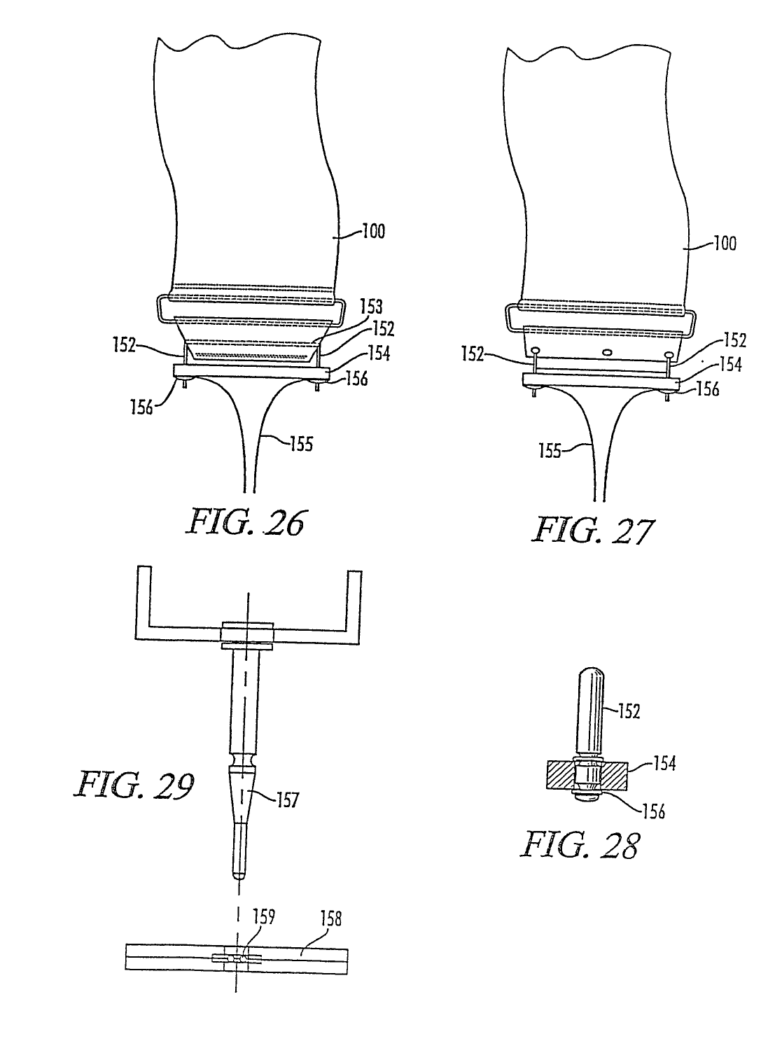

Optionally, other types of connectors or “break-away” switches may be provided in lieu of the ball and socket connectors described. For example, optional embodiments employing a number of types of insertion pin structures are illustrated in FIGS. 26 through 29. FIGS. 26 through 28 show a pair of variations on a similar structure employing a pair of pins at each forcible release assembly. The structure of FIG. 26 employs pins 152 which are connected together by a crossbar 153, and the structure of FIG. 27 utilizes individual pins. In each structure, the pins are fixed to the flexible strap 100 in a suitable manner, and each of the pins extends through a plate 154 mounted on the receptacle. Each of the pins has a first annular groove, and a ring 156 is situated in each of the first annular grooves of the pins. The rings, as well as the pins, may be electrically conductive and the rings are preferably each connected to the alarm circuitry (e.g., by wires 155) such that removal of one or both of the pins destroys the electrical continuity between the wires connected to the rings, and triggers the alarm circuitry. Optionally, the plate 154 may be formed of insulative material and the continuity provided by the pins and the pin mounting structure (e.g., the crossbar) with the continuity being broken by forcible removal of the pins from the rings, or the plate may be electrically conductive with the continuity being broken by forcible removal of the pins from the plate.

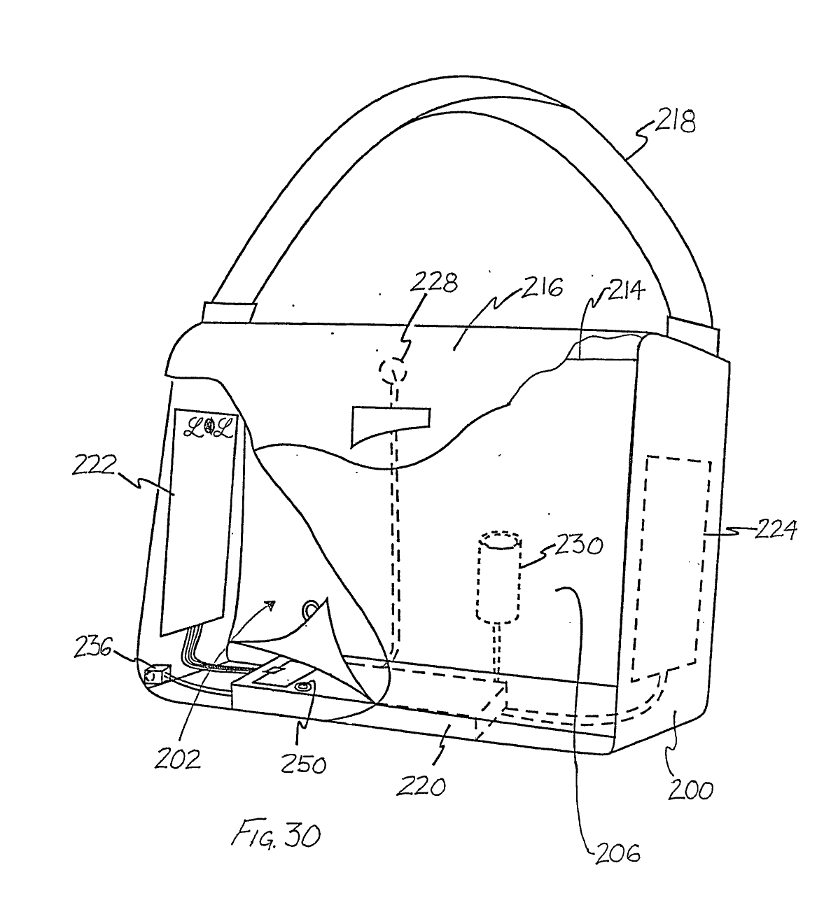

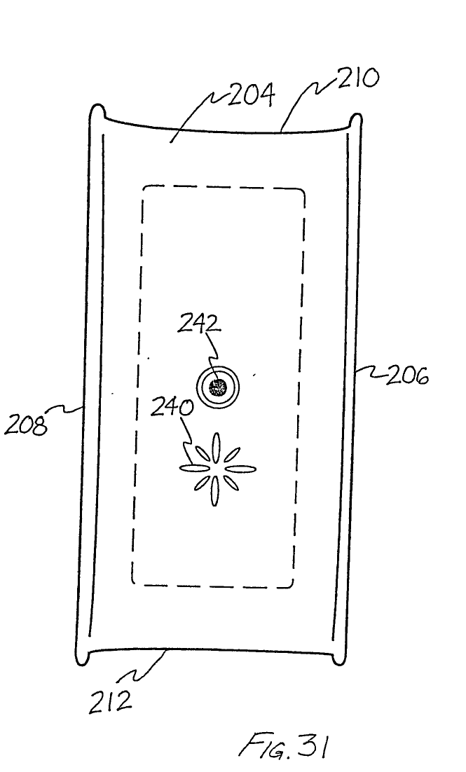

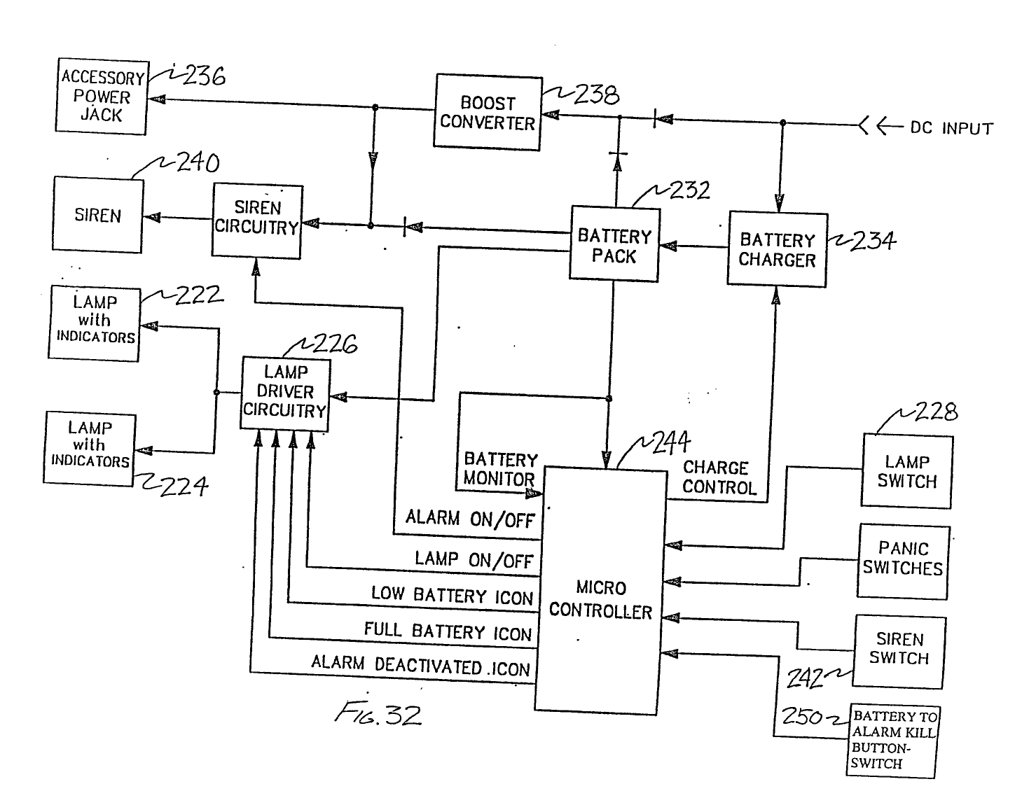

Another variation of the forcible release assembly is shown in FIG. 29, and the structure of this variation employs a single pin 157 having an annular groove, and a base member 158 having an aperture with a pair of rods 159 extending in a substantially parallel orientation across the aperture. The rods are biased together for situating in the annular groove when the pin is inserted into the aperture, and the biasing of the rods requires that substantial force be applied to the pin to remove it from the aperture to trigger an alarm. The alarm circuitry may be triggered by removal of the pin from the aperture, and the triggering signal may be generated by any suitable means. This variation of the forcible release assembly may be preferable in that the withdrawal of the pin from the aperture does not require destruction of the rods, and therefore the pin may be reinserted into the aperture for subsequent reuse of the receptacle with the forcible release assembly intact.

Preferably, the system further includes an insert 110 for being removably positioned in the interior compartment of the receptacle. The insert has an insert casing 111 formed from a flexible material. The insert casing includes a bottom wall panel 112, a front wall panel 113, a rear wall panel 114, and a pair of end wall panels 115,116. The front, rear, and end wall panels extend upwardly from the bottom wall panel for defining an open top and an interior of the insert. The insert casing may optionally include a flexible insert strap 117, and may optionally include a flexible insert flap 118 for positioning over the open top of the insert casing. The front all panel and the rear wall panel may comprise a transparent material. Optionally, any of the various faces of the purse insert may be opaque, translucent, or transparent. Opaque materials that may be used include leather, vinyl, and the like. The insert casing may also have a bottom compartment 121 for a purpose described below.

As shown in FIG. 10, the end wall panels of the insert casing may optionally each include a pair of sleeves 119 with open bottom ends for use with the optional frame of the invention. Such sleeves each preferably encompass the entire associated end wall panel. In use, the insert is inserted into the interior compartment of the receptacle. In this orientation, the sleeves of the insert casing removably receive the primary side walls of the frame of the receptacle while the secondary side walls remain between the end wall panels of the insert casing and the end panels of the receptacle. See FIG. 13.

An insert electrical assembly may also be provided for the insert, and mounted on the insert. The insert electrical assembly 120 is preferably mounted in the bottom compartment 121 of the insert casing. The insert electrical assembly includes a timer mechanism 122 for generating an actuation signal for a predetermined amount of time upon the actuation thereof (See FIG. 25). A button maybe situated on the insert, and is connected to the timer mechanism for actuating the timer mechanism upon the depression of the button. A power source 123 is mounted on the insert for supplying power to the illumination source of the insert and circuitry on the receptacle, including the alarm apparatus. The power source comprises at least one battery mounted on the insert casing. In the embodiment of FIG. 13, the battery may be connected to a pair of conductive sleeve contacts 99 on the frame of the receptacle for electrically connecting the insert electrical assembly with the receptacle electrical assembly when the insert is positioned in the receptacle. The battery may have a first mode when the receptacle is situated on the charging base during which power from the charging base is supplied to the battery through the receptacle for recharging the battery, and may also be supplied to the power adapting apparatus for recharging an electrical device located in the receptacle. The battery may also have a second mode when the receptacle is removed from the charging base, and during the second mode the battery supplies power to the receptacle electrical assembly 124 (e.g., the alarm apparatus) and the insert electrical assembly 120 (e.g., the illumination apparatus), and may also supply power through the power adapter connector to an electric device 150.

Significantly, an illumination apparatus is mounted on the insert for illuminating the insert. The illumination apparatus comprises a light source, and in some embodiments, a light diffusion structure. The light diffusion structure includes at least one illuminating liner panel 131,132 in communication with the light source. The liner panel or panels preferably line an interior surface of the end wall panels of the insert casing. Optionally, the liner panel may comprise a light diffusion structure including a plurality of fiber optic strands. The fiber optic strands are preferably interwoven into a matrix of fiber optic strands to define a fabric structure. The ends of the fiber optic strands may be bundled together by a clamp. The light source is positioned adjacent to the ends of the fiber optic strands of the fiber optic liner panels for illuminating the strands.

It should be understood that various other fiber optic liners may be employed in lieu of the one set forth hereinabove per the desires of the user. Suitable fiber optic material is readily available in the marketplace, such as from the Lumitex Corp. Further, as an option, other types of illumination apparatus may be employed such as those employing chemilluminescent, fluorescent, incandescent, laser, LED, infrared, or other wavelengths of light, or any other type of light which can assist a user to see in the interior of the receptacle. Even more preferably, the liner panels may comprise panels of electroluminescent material, which provide both the light source and the light diffusion structure.

A timer mechanism 122 may be provided on the insert for causing illumination of the illumination apparatus for a predetermined period of time upon the closing of a switch. The illumination apparatus is connected to the timer mechanism, and the illumination apparatus is supplied with power for a period of time by the timer mechanism after the timer mechanism is activated. The timer mechanism may be adapted for illuminating the illumination apparatus for a predetermined amount of time (such as, for example, a period of 15-30 seconds) after the activation of the timer mechanism. See FIG. 16. Optionally, a switch in the form of, for example, a button with a dial, or other suitable mechanism, may be employed to bypass the timer to provide a power on/off function.

An optional charging apparatus may be provided for providing power to the power source, or battery, for recharging the battery. See FIG. 23. The charging apparatus may provide power for recharging the battery of the liner (or the receptacle) through the receptacle. The receptacle is removably mountable on the charging apparatus. The charging apparatus comprises a charging base 70 with at least two second conductive contacts 74, 75 mounted on the charging base for electrically contacting the first conducting contacts of the receptacle. The second conductive contacts may be mounted on a top face of the charging base. Optionally, a charging light 126 may be mounted on the charging base, with the charging light being connected between the conductive contacts and a primary power source. The charging light is adapted to illuminate upon the flow of current through the conductive contacts. A full charge light 127 may be mounted on the charging base for illuminating when a full charge condition of the battery is detected. While electric communication between the receptacle and the charging base may be effected by interlocking structures such as complementary slots and posts, it should be understood that surfaces without significant contour, such as flat surfaces, may be employed on the receptacle and charging base.

While a physical electrical contact has been disclosed hereinabove to carry out the recharging of the battery using the charging base, it should be understood that other types of electrical communication may be relied upon for recharging. For example, a coil and post combination may be provided for affording inductive electric communication. As an option, a cigarette lighter cord and plug may be connected to the adapter connector of the power adapter apparatus such that the battery may be recharged in a vehicle as opposed to using the charging apparatus.

The system of the invention may also include an alarm apparatus for providing an audible alarm upon triggering of the alarm apparatus 135. The alarm apparatus is mounted on the receptacle. The alarm apparatus is electrically connected to the power source or battery of the insert or a battery contained in the receptacle, especially if no insert is employed. The alarm apparatus may include a siren 136 for producing a loud sound when the alarm apparatus is triggered. The siren is mounted on the receptacle, preferably on the bottom panel of the receptacle. The alarm apparatus may be triggered in at least two ways. The alarm apparatus may be triggered upon the removal of a strap attached to one of the forcible release assemblies 101, 102 of the receptacle. An alarm activating switch 137 may be mounted on the bottom panel of the receptacle, and the alarm activating switch may be adapted to trigger the alarm apparatus when the alarm activating switch is actuated. Optionally, the siren may be centrally located in a depression 138 or recess in the bottom panel of the receptacle, and one or more alarm activating switches may be positioned in or closely adjacent to the perimeter of the depression or recess.

A pocket 140 may be provided for removably receiving an electrical device that is desired to be carried by the user. Preferably, the pocket is located in the interior compartment of the receptacle, and is formed on one of the panels of the receptacle (See FIG. 19). As an option, the pocket may be formed on the insert (See FIG. 12) to removably receive the various aforementioned electronic devices.

Significantly, a power adapting apparatus may be provided for supplying power to an electrical device carried in the receptacle, such as in the pocket if the receptacle is so provided. The power adapting apparatus is mounted on the receptacle, and is connected to the power source or battery mounted on the liner. An adapter connector 98 is situated on the receptacle, and may be situated in the pocket for engaging an electrical device positioned in the pocket. In one embodiment, the adapter connector 148 is adapted to releasably connect to the electronic device by simply sliding the electronic device in the pocket (See FIG. 21). This may be accomplished with strip contacts and the like. Ideally, the universal recharging adapter is capable of connecting with any one of a plurality of electronic devices.

The adapter connector may optionally be provided in another location on the receptacle, and may even be located on the exterior of the receptacle. For example, a plug-in power adapter may be mounted to the top end of one of the secondary side walls (See FIG. 13) for being releasably connected in electric communication with a portable electronic device 150. The portable electronic device may comprise a portable telephone, a paging device, a calculator, a portable computing device, a video game, or any other type of electrically powered device that may use electrical power supplied by the battery of the insert, or includes its own rechargeable battery that may be recharged simultaneously with the battery of the electric system for the receptacle when the receptacle is placed on the charging base 70.

A charge status indicating light 128 may be provided on the receptacle or the insert for illuminating when a low charge condition is detected in the battery or batteries of the insert or receptacle.

For transferring power from the receptacle to the battery of the insert when the battery is being charged, and from the insert to the receptacle for powering the alarm system, one optional embodiment of the invention includes a connector surface 141 on the outer housing of the receptacle, and a tab 142 extending from the insert casing of the insert. The tab of the insert is adapted to be positionable substantially adjacent and parallel to the connector surface 141 of the receptacle when the insert is positioned in the interior of the receptacle. See FIG. 19. The connector surface 141 has a first portion 143 of a first connector mounted thereon, and the second tab has a second portion 144 of a first connector mounted thereon, and the portions of the first connector are removably connectable together. The first and second portions of the first connector are electrically conductive to permit electricity to flow between the first and second portions of the first connector when the portions are physically connected. The first and second portions of the first connector may comprise first and second halves of a snap connector. The connector surface 141 also has a first portion 145 of a second connector mounted thereon, and the second tab has a second portion 146 of a second connector mounted thereon, and the portions of the second connector are removably connectable together. The first and second portions of the second connector are electrically conductive to permit electricity to flow between the first and second portions of the second connector when the portions are physically connected. The first portion of the first connector and the first portion of the second connector are each in electrical communication with the receptacle electrical assembly (e.g., the alarm assembly). The second portion of the first connector and the second portion of the second connector are in electrical communication with the insert electrical assembly (e.g., the battery and the illumination assembly).

A switch 125 (such as, for example, a push button) may optionally be mounted on the second tab of the insert casing for activating the timer mechanism for illuminating the illumination apparatus for a period of time.

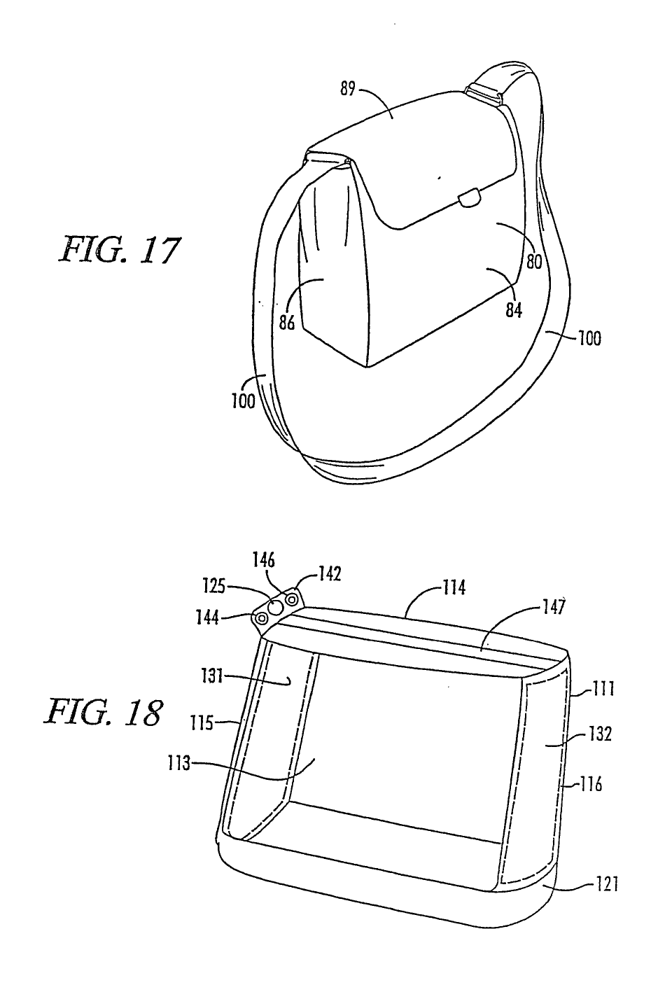

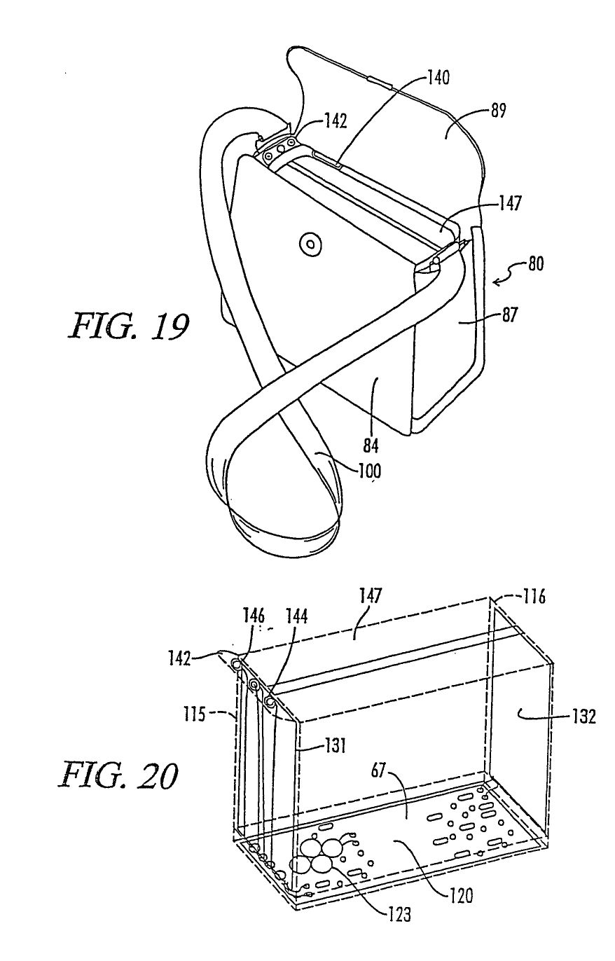

Optionally, the insert casing may be provided with a top wall panel 147 that closes the open top. The top wall panel has a closable slit that extends substantially parallel to the front and rear wall panels. See FIGS. 18 and 20.

In further detail, one embodiment of the timer mechanism (See FIG. 16) preferably includes a 555 timer with an output connected to an NPN transistor which drives a relay. Such relay is connected to the light source for supplying sufficient voltage to the light source. Ideally, each of the components of the electrical assemblies of both the purse insert and carriage are miniaturized and of a minimal weight. Further, as an option, a dimmer may be included for controlling an intensity in which the lamp and fiber optic liner are illuminated. Such dimmer may take the form of a potentiometer used in place of one of the resistors shown in FIG. 16.

In various alternate embodiments, the concepts of the receptacle and insert may be employed in the arts of luggage, plastic bags, waterproof scuba bags, military & camping backpacks, general purpose back packs, emergency medical equipment containers, emergency fire fighting equipment containers, police equipment containers, NASA-shuttle and space station tool and equipment bags which contain emergency items, underground utility and mining pouches, plumber tool bags, or virtually any other receptacle. It should be further noted that the various components of the present invention may be compiled into a single receptacle for affording a simpler design.

It will be realized that a possible embodiment of the invention could have the insert of the invention omitted from the structure, and the various features of the insert incorporated on or into the receptacle. It is noted that an embodiment of the invention lacking the removable insert would thus lack the quick and easy movement of the features (e.g., the illumination apparatus) of the insert between different receptacles, including any contacts of the insert. The insert permits this quick and easy interchange of the illumination apparatus, the battery (if included on the liner), and any contacts of the liner between a variety of receptacles. Nonetheless, some or all of the features of the insert may easily be incorporated into the receptacle or container.

One embodiment of the invention in which the receptacle is employed without the insert is illustrated in FIGS. 30 through 35. The embodiment includes a receptacle with an adaptable electric accessory system for powering an electronic device through a device connector.

The receptacle 200 has an interior compartment 202 which may be defined by a bottom panel portion 204, opposed front 206 and rear 208 panel portions that extend upwardly from the bottom panel portion, and opposed end panel portions 210, 212 that extend upwardly from the bottom panel portion and that extend between the front and rear panel portions. The receptacle may have an upper opening 214, and may include a flap closure 216 that extends from one of the front and rear panel portions. A strap 218 may be provided for supporting the receptacle on the shoulder of the user, and the strap may have opposite ends attached to the end panel portions of the receptacle.

A case 220 may be mounted on the receptacle, and the case 220 may be located in the interior compartment of the receptacle, preferably but not necessarily being located adjacent to the bottom panel portion of the receptacle.

An illumination assembly may be provided for illuminating the interior compartment of the receptacle (see FIG. 34). The illumination assembly may comprise a pair of illumination panels 222, 224 mounted on the receptacle, although less than or more than two panels may be employed. Preferably, the illumination panels 222, 224 are positioned in an opposed relationship in the interior compartment of the receptacle such that the illumination panels face each other. The illumination panels 222, 224 may comprise electroluminescent panels. The illumination assembly may also include illumination driver circuitry 226 for controlling illumination of the illumination panels 222, 224. The illumination driver circuitry 226 may include an inverter that produces a high voltage alternating current output that is suitable for illuminating, for example, electroluminescent panels. A switch 228 may be provided for causing illumination of the illumination panels, and may be operatively connected to the illumination driver circuitry 226. The switch 228 may be located in the interior compartment 202 of the receptacle, and may be located adjacent to the upper opening 214 of the receptacle. Optionally, the switch 228 may also function as a program mode switch for controlling the modes of operation of the controller and the alarm system, such as for enabling and disabling the alarm system. The changing of modes may be accomplished, for example, by repeated actuations of the switch 228 by the user within a predetermined time period.

A power supply assembly may be included for providing power to an electronic device that may be carried in the receptacle on occasion. The power supply assembly may comprise an accessory power connector 230 that removably connects to a power input on the electronic device to provide power to the electronic device for operating the electronic device and charging any battery incorporated in the electronic device. The accessory power connector may be of a type suitable for connecting to the particular device that is desired to be carried in the receptacle. One type of connector may be a jack that accepts plugs designed for insertion into the cigarette lighter and has become a relatively standardized connector for low voltage power transmission. Other, more specialized or proprietary connectors may be employed as the accessory power connector, such as connectors designed to connect directly to portable cellular telephones. Optionally, the receptacle may be provided with more than one type of connector that may be removably connected to the apparatus, such as the case, so that the user may select the suitable type of connector needed for the electronic device desired to be carried in the receptacle for charging. As a further option, multiple accessory power connectors may be simultaneously connected for simultaneously charging or operating electronic devices carried in the receptacle. Wires may be provided to connect the accessory power connector to the case, and optionally the wires may include a connector that is removably connected to the case.

A power source assembly may be included for providing power to the illumination assembly and the power supply assembly. The power source assembly may comprise a battery 232, such as a rechargeable battery. The power source assembly may also comprise a battery charger device 234 for charging the battery 232. The power source assembly may also include a power charging jack 236 for connecting to an external power source (not shown) to provide power to the battery charger device 234. The power charging jack 236 may be mounted on the receptacle in a manner permitting access to the power charging jack from an exterior of the receptacle (see FIG. 30). The power charging jack may be located adjacent to the bottom panel portion of the receptacle, and may be mounted on one of the end panel portions 210, 212 of the receptacle such as near a lower corner of the receptacle. The power source assembly may also include a converter 238, such as a boost converter, for converting a voltage supplied by the battery to an output voltage that is suitable, for example, for electronic devices removable connectable to the accessory power connector jack, and optionally for other components of the system of the present invention. The power source assembly may simultaneously or sequentially provide power to the battery and the power supply assembly. Optionally, a kill switch (not shown) may be provided that when actuated disconnects all of the systems and features of the invention from power provided by the battery.

An alarm assembly may also be included for providing an audible alarm that may be actuated by the user when the user desires to draw attention to herself or himself, such as when the user feels threatened by someone. The alarm assembly may include a siren 240 for producing an audible alarm. The siren 240 may be adapted to direct the audible alarm through one of the panel portions of the receptacle to an exterior of the receptacle for maximizing the volume of the siren that may be heard by bystanders. The siren 240 may be located at a bottom of the receptacle such that the audible alarm is directed exteriorly of the receptacle from the bottom through the bottom panel portion. The siren 240 may be mounted on the case for directing sound through the bottom of the receptacle.

The alarm assembly may include an actuating switch 242 for activating the alarm assembly. The actuating switch 242 may be accessible through the bottom panel portion of the receptacle, and the switch may be located adjacent to the siren on the receptacle. The actuating switch 242 may comprise a button mounted on the case, and the button may be located adjacent to the siren. Once triggered, the sound of the alarm may optionally be turned off by pressing the actuating switch for a predetermined period of time (or for a predetermined number of times).

A controller assembly may be included for controlling operation of the illumination assembly and alarm assembly. The controller assembly may comprise a controller 244 that is operatively connected to the illumination assembly and the alarm assembly. The controller may be suitably programmed to perform a timing function for controlling the duration of various functions of the invention, including the illumination function of the illumination assembly. It should be understood that the term controller is intended to include any device or circuitry that is able to monitor inputs, and execute one or more steps or actions in response to the one or more inputs. Illustrative controllers include microcontroller circuits and microprocessor circuits. The controller assembly may also include charge indication means for indicating an amount of electrical charge in the battery 232, and may be adapted to sense the amount of charge held in (or current being drawn by) a battery hooked up to the power supply assembly. The controller may discontinue charging when it is detected that little or no current is being drawn by the device, and may resume or begin charging when the amount of electrical charge present in the battery is detected to be less than a full charge. The charge indication means may comprise a pair of illuminating indicators 246, 248. The illuminating indicators 246, 248 may be mounted on one of the illumination panels 222, 224. A first one 246 of the illuminating indicators may illuminate when the battery is fully charged, and a second one 248 of the illuminating indicators may illuminate when the electrical charge in the battery 232 is low or, optionally, less than a full charge. Additionally, an alarm status indicator 245 may be employed that indicates the current operational status of the alarm system, such as an enabled status or a disabled status. For example, a disabled status of the alarm system may be indicated by a flashing of the alarm status indicator 245, and an enabled status of the alarm system may be indicated by the indicator not being illuminated.

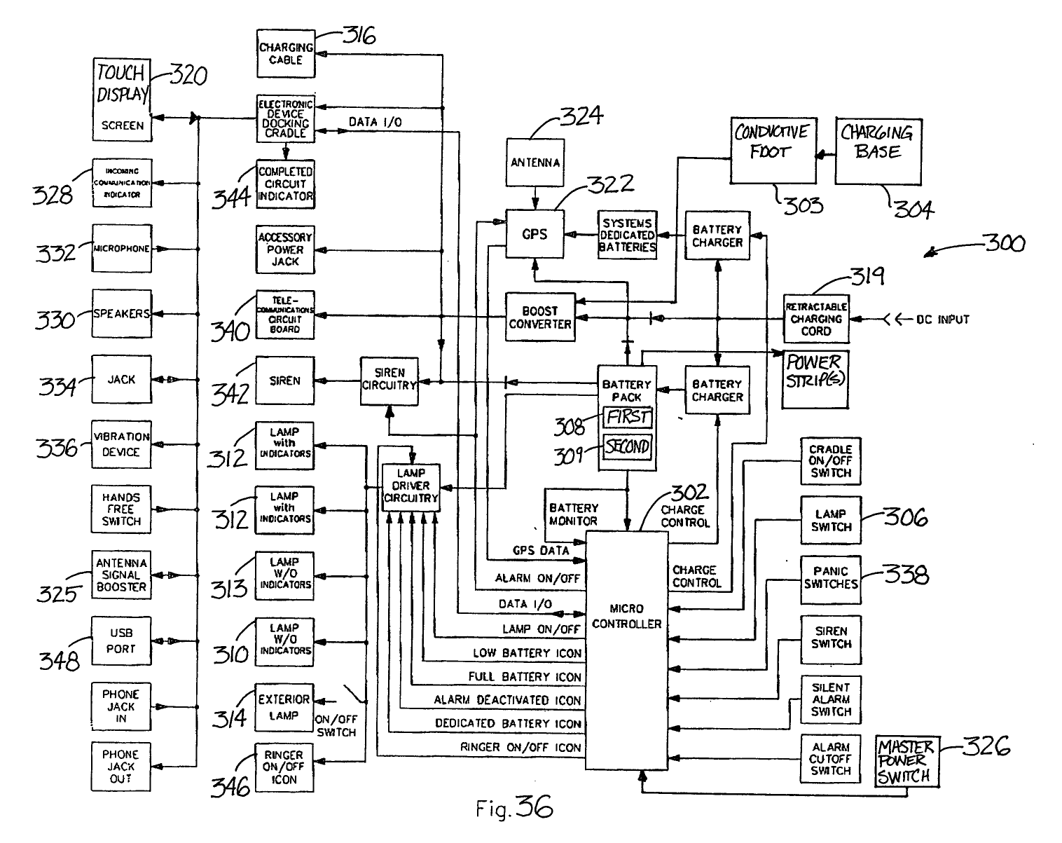

A further embodiment of the invention, shown in FIG. 36, includes a receptacle 300 that includes a plurality of additional optional features for the invention. The receptacle 300 is preferably configured to receive either in its interior, or on its exterior (such as in a docking cradle positioned in the pocket 140), an electronic device 301 that may include a rechargeable battery as a power source. Many of the features of the receptacle 300 described herein are especially useful with electronic communication devices such as cellular telephones, pagers, two-way radios, or other devices employing wireless communication technology such as a personal digital assistants (PDA) and small scale computing devices. The receptacle 300 may include processing means (such as a central processing unit or microprocessor 302) for handling and coordinating various operations and functions of the receptacle described in greater detail below. It should be noted that, except when mutually exclusive, the features of the various embodiments may be combined as desired while remaining within the intended scope of the disclosure.

In one embodiment of the receptacle 300, an underside of the receptacle 300 may have one or more feet (not shown) that are electrically conductive for making physical contact and an electrically conductive connection with an electrical contact on an electrical charging base for charging one or more batteries that are associated with the receptacle. The charging base may be designed to allow for various sized receptacles to sit on the charging base without any particular contact point alignment necessary, with contacts located over a large portion of the upper surface of the charging base.

With respect to the inductive charging base mentioned earlier in this description, it should be appreciated that a suitable inductive charging base 304 may have a flat upper surface on which the receptacle may be rested for inductively charging one or more batteries without having to physically align and connect a battery by electrical conductor to the changing base. Optionally, the receptacle 300 may include more than one battery 308, 309 so that each battery may be dedicated to one or more functions of the system so that the failure of one battery does not cause all of the functions of the system to be lost. Each of the batteries 308, 309 may have its own dedicated battery power level status indicators.

In the receptacle 300, an additional illuminating panel 310 may be employed on the interior of the receptacle, as well as the pair of illuminating panels 312, 313 on the end panels of the receptacle. Optionally, an illuminating panel 314 (or optionally more than one illuminating panel) may be located on the exterior of the receptacle 300 and may be illuminable separately of the illumination panels 310, 312, 313, on the interior of the receptacle. A power (or on/off) switch 306 may be provided to activate and deactivate the illuminating panels on the interior and the exterior of the receptacle 300.

As a further option, the invention may include a battery charging power cord 316 that is connectable to various electronic devices associated with the receptacle that require battery charging for providing direct or back-up power to an electrical device when the battery of the device is uncharged or it is otherwise desirable to operate the electrical device directly from the battery or power source of the receptacle 300. The power cord 316 may be provided with a universal plug, or may be utilized with a set of removable and interchangeable plugs that may be suited to connect to a number of different types and brands of devices. The battery charging cord 316 may be mounted on an automatic retracting mechanism and automatic brake mechanism that permits recoil upon a simple tug of the cord 316. Thus, the power cord 316 may be dispensed under spring tension from a spool located in a compartment on the receptacle 300, and the automatic braking mechanism may automatically brake the spring tension when the cord is withdrawn from the spool. Optionally, a manual system may also be used which employs a manual brake and release mechanism for the power cord and spool.

As a still further option, a retractable power cord 319 may be provided for supplying power to the various system and power sources or (rechargeable) batteries of the receptacle 300. In one embodiment of the retractable power cord, the end of the power cord may comprise a standard household current plug for connecting to a household current receptacle (with suitable adjustments made in the current and voltage). The receptacle may also include a power strip in the interior (and/or on the exterior) of the receptacle, which may include one, two, or more household current receptacles for receiving the plugs for various devices (such as charging stands or docking cradles) designed to plug into conventional household receptacles. The flow of power through the power strip may be subject to various current and voltage controls that protect against overloads and power spikes that might damage the circuitry of the connected device or the receptacle. The plug receptacles of the power strip may be adapted to receive whatever conventional plug is in use in the country of use of the receptacle. Optionally, the receptacle 300 may be provided with a two part docking cradle that includes a relatively universal part connectable to the power strip, and a specialized part that is mateable to the universal part and that may be tailored for interfacing with the power inputs of the device. The specialized part may then be replaced on the universal part when a new or different device is used with the receptacle 300. Optionally, a one-part and two-part docking cradle may plug directly into the power strip without the use of a typical cord and plug arrangement. The power strip may be connected to the receptacle circuitry

Optionally, status icons such as alarm status indicator 245 and illuminating indicators 246, 248, may optionally be located anywhere on the exterior or in the interior of the receptacle. The status icons may indicate the operating (or non-operating) status of any of the systems of the receptacle or the devices that are connected or otherwise associated with the receptacle.

A cradle or pocket of the invention that receives the electronic device, such as pocket 140, may be located in the interior of the receptacle (see for example FIG. 12) or on the exterior of the receptacle. Similarly, the power connector, such as the adapter connector 148 and 230, may be located on the interior as shown in FIG. 21 or on the exterior of the receptacle.

As still another option, the receptacle 300 may include a systems access—view screen device 320 (hereinafter referred to as a “display” or “display screen”) that may be located on the interior or on the exterior of the receptacle. The display screen is preferably a relatively lightweight and thin, and may be relatively flexible to conform to a wall of the receptacle. The circuitry (such as microprocessor 302 or other dedicated video driver chip) generating the images on the display screen may be adapted to be interfaced with the electronic device or devices in order to generate an image on the display that is the same or similar to the images and information being displayed on a display screen of the electronic device 301 itself. Status information for the system of the receptacle 300 (and optionally any electronic devices associated with the receptacle) may also be displayed on the display, or may optionally be displayed on other display screens on the receptacle 300 (if so provided). As a further option, the display 320 may be touch sensitive so as to be activatable by the touch of a finger or a stylus of the user to input information into the system. Optionally, the display screen 320 may be voice activated and accept input in that manner. As a further option, the display screen 320 may be adapted to send and receive commands wirelessly through infrared transmissions. The display screen 320 may thus be able to accept input from the user as to the functions of the various systems of the receptacle and even the electronic devices associated with the receptacle. The number of separate controls (such as buttons and witches) on the receptacle may thus be reduced by using the display screen 320 to activate and deactivate the various functions of the receptacle.

The display 320 or displays may be substantially permanently mounted on the receptacle 300 or one or more of the displays may be removable from the receptacle and be operable separate of the receptacle. A detachable display screen 320 may include an antenna, microphone, and a speaker to permit the display screen to function as an independent communication device. The display screen 320 may thus act as an interface with computing devices of networks of computing devices. The display screen may also include wired ports using Universal Serial Bus (USB), FireWire, or other ports heretofore known to that will be developed. Various functions of the display screen may be voice activated by the user using the microphone on the display screen. The display screen 320 may also include its own dedicated power source (such as a rechargeable battery) for powering its system when the display screen is separated from the receptacle, and that power source may be recharged from the power sources of the receptacle.

As yet a further option, the receptacle 300 may also incorporate a global positioning system (GPS) receiver system 322 that displays the current position of the receptacle for assisting the user of the receptacle in locating his or her position. The information generated by the GPS receiver system 322, such as current position, altitude, and the like, may be displayed on the display 320. The receptacle 300 may also be provided with an antenna 324 in communication with the circuitry of the GPS receiver system 322 for providing reception of the GPS signals to the system circuitry. Optionally, the antenna 324 may be integrated into the power cord 316 described above.

An antenna 325 may also be connectable to the wireless communication device 301 or devices located in or on the receptacle 300. The antenna 325 may work in conjunction with a signal monitoring and signal boosting device (not shown). The signal may be received by the antenna 325 and then pass through a signal monitoring and signal boosting device which can attenuate or totally remove microwave radiation. Optionally, the signal from the antenna 325 may be transmitted to the communication device 301 through the back-up power cord 316, although other means for transmitting the received signal to the communication device may be employed.

An on/off power switch 326 may be provided for controlling battery power flow from the primary receptacle battery to an electronic device connected to the power connector. The switch 326, which may be embodied as a button, allows the user to choose whether the electronic device 301 will automatically draw power from the primary receptacle battery until the electronic device is fully charged, or the power of the primary receptacle battery may be prevented from recharging the battery of the electronic device to thereby preserve the power of the primary receptacle battery for other purposes such as the lights and the other systems relying upon the primary receptacle battery for power. Optionally, the switch 326 may not affect the recharging of the electronic device 301 when the entire system on the receptacle 300 is being recharged from an external power source, which may cause an override of the switch.

As a further option, an exterior indicator light 328 (such as a light emitting diode) may be located on the exterior of the receptacle 300 and may blink to provide the user of the receptacle 300 with a visual alert that a telephone call or a page is being received by the electronic communication device located in or on the receptacle, and thus the ringer of the communication device may be turned off or may be left on. Indicator means may also optionally be present on the display screen 320.

Optionally, the receptacle 300 may include one or more speakers 330 and may include a microphone 332. A jack 334 may be located on the exterior of the receptacle 300 for receiving a plug from a device such as headphones (not shown) for accessing the output of an electronic communication device 301 that is located in or on the receptacle. In one embodiment, when the headphones are plugged into the jack 334, the exterior speaker 330 and microphone 332 may be deactivated. Optionally, if a wireless headphone assembly is being used, the speaker 330 and microphone 332 may likewise be deactivated.

The receptacle 300 may also include a vibration device 336 for vibrating at least a portion of the receptacle to thereby alert the user of the receptacle of an incoming call or page received by a communication device 301 seated in a cradle in the receptacle and interfaced to the microprocessor 302 of the receptacle. The vibration device 336 may be operable whether or not the ringer of the communication device 301 is operable. In one embodiment, the vibration device 336 may be linked to a strap of the receptacle 300 in order to communicate the vibratory motion of the vibration device 336 to the receptacle. Optionally, the vibration device 336 may be located adjacent to or on the strap of the receptacle 300. The vibration device 336 may have its own dedicated switch, or it may be linked to a switch or control which controls a number of the functions of the system or various devices.

In one embodiment of the invention, a multi-purpose switch (not shown) may be provided on the receptacle 300 for operating various components or system of the receptacle. Optionally, the switch may be operated from the exterior of the receptacle 300 without requiring the user to reach into the interior of the receptacle.

If the receptacle is so configured, an external speaker 330, a microphone 332 and a display screen 320 mounted on the receptacle 300 may be electrically connectable to an electrical communication device 301 when the communication device is associated with (or connected to) the receptacle. The user may thereby conduct a so-called “hands-free” conversation over the communication device 301 without having to remove the communication device from the interior of the receptacle 300 or a pocket on the receptacle. Prior to taking the call, the user may view the identity of the caller (or the number from which the caller is calling) on the display screen 320 without having to remove the communication device 301 from the receptacle 300. Further, if the communication device 301 has voice-activated dialing capabilities, the user may also utilize this function using the microphone 332 without having to remove the communication device from the receptacle 300.

Optionally, the receptacle 300 may include a silent alarm system and/or an audible alarm system, each of which can be triggered by separate panic switches 338 or buttons located on the receptacle. Both the silent and audible alarm systems may be capable of initiating a call to emergency assistance services (such as the 911 system) upon the actuation of the triggering button, and the microphone may be enabled by the alarm system to detect and transmit any sounds emanated about the receptacle over the communication line to the assistance service when one of the alarms is triggered. Also, the GPS receiver system 322 may be activated to send location information for the receptacle 300 over the communication line when one of the alarms is triggered. It will be appreciated that the audible alarm system also causes sound to be emanated from the speaker 330 or from a siren 342 when the audible alarm system if triggered, while the silent alarm system does not trigger any audible sound through the speaker.

Optionally, telecommunication circuitry 340 may be integrated into and thus be inseparable from the receptacle 300 by including the telecommunication circuitry with the other circuitry of the systems of the receptacle. A receptacle so equipped permits the silent and audible alarms of the system of the receptacle to place a call to emergency assistance services when the alarm is triggered even when a communications device is not connected to the receptacle. The integrated telecommunication circuitry 340 may also operate in conjunction with the GPS receiver system 322 to identify the location of the receptacle 300 when an alarm is triggered and the external microphone 332 on the receptacle to detect any sounds in the environment of the receptacle when the alarm is triggered and transmit those sounds to the emergency assistance services when the alarm is triggered.

A status light indicator 344 may be located on the receptacle 300, such as adjacent to the cradle or the pocket, may turn on for a predetermined period of time, to indicate a complete connection has been established between the removable electronic device circuitry and the circuitry of the receptacle.

Optionally, an icon 346 may be provided on the receptacle 300 that indicates to the user whether the ringer or other audible warning is enabled or disabled on the electronic communication device 301 connected to the receptacle. The icon 346 may be displayed on the display screen 320, and may, for example, blink to confirm that the ringer of the electronic communication device 301 is off or disabled when the communication device is connected to the receptacle, such as by being positioned in the receptacle. The icon 346 may be displayed continuously when the ringer of the communication device is operable. Optionally, separate icons may be used to indicate status of various systems of the receptacle 300.

As a further option, a Universal Serial Bus (USB) port 348 may be provided on the receptacle 300 for transferring power to a connected electronic device 301 or even for the transfer of information if the receptacle is provided with processing or memory circuits such as microprocessor 302. As a further option, the receptacle 300 may be provided with wired telephone jacks (see FIG. 36).

As a still further option, the circuitry of the systems of the receptacle 300 may be positioned at various locations on and in the receptacle, and may be housed in a relatively rigid or a relatively soft and flexible housing.

Optionally, a liner such as shown in previously described embodiments may be included with the receptacle 300, and may have any or all features of the receptacle 300. The liner may operate and recharge in or out of the receptacle 300.

Optionally, any and all of the above described switches and controls may be located on the interior or on the exterior of the receptacle 300, and may or may not be illuminable for a finite period of time (permanently set or adjustable) or continuously. Similarly, all jacks and connection structures may be located on the interior or on the exterior of the receptacle 300.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A receptacle system for powering an electronic device, the system comprising:
a receptacle having an interior compartment;
interfacing means for interfacing with the electronic device;
processing means on the receptacle for processing signals from the electronic device received through the interfacing means; and
powering means mounted on the receptacle for powering the electronic device.

2. The system of claim 1 wherein the powering means comprises a rechargeable battery mounted on the receptacle.

3. The system of claim 1 wherein the powering means comprises a battery charger mounted on the receptacle for connecting to the electronic device through the interfacing means for charging a battery of the electronic device.

4. The system of claim 1 wherein the interfacing means comprises a power charging plug removably connectable to the electronic device.

5. The system of claim 1 additionally comprising illuminating means for illuminating the interior compartment of the receptacle.

6. The system of claim 1 additionally comprising alarm means for producing an alarm upon triggering of the alarm means.

7. The system of claim 6 wherein the alarm means comprises an audible alarm apparatus that emits an audible sound upon triggering of the alarm apparatus.

8. The system of claim 6 wherein the alarm means comprises a silent alarm apparatus that does not emit an audible sound when triggered.

9. The system of claim 6 wherein the alarm means comprises means for transmitting environmental sounds detected about the receptacle over a telecommunication device when the alarm means is triggered.

10. The system of claim 1 additionally comprising a microphone mounted on the receptacle for detecting sound about the receptacle.

11. The system of claim 1 additionally comprising a display screen mounted on the receptacle.

12. The system of claim 11 wherein the display screen is located on an exterior of the receptacle, the display screen being operably connected to the processing means, the display screen being operably connectable to the electronic device through the interfacing means.

13. The system of claim 1 additionally comprising an antenna mounted on the receptacle, the antenna being operably couplable to the electronic device through the interfacing means.

14. The system of claim 1 additionally comprising a global positioning satellite (GPS) receiving system mounted on the receptacle and being operably connected to the processing means.

15. The system of claim 1 additionally comprising telecommunication means mounted on the receptacle and being operably connected to the processing means.

16. The system of claim 1 additionally comprising a vibrator mounted on the receptacle, the vibrator being operably connectable to the electronic device through the interfacing means such that the vibrator vibrates when a call is being received by the electronic device.

17. The system of claim 16 wherein the receptacle includes a carrying strap, the vibrator being located adjacent to the carrying strap.

18. The system of claim 2 additionally comprising a charging base for inductively charging the rechargeable battery of the powering means when the receptacle is positioned adjacent to the charging base.

19. The system of claim 1 wherein the powering means comprises a rechargeable battery mounted on the receptacle;
wherein the powering means comprises a battery charger mounted on the receptacle for connecting to the electronic device through the interfacing means for charging a battery of the electronic device;
wherein the interfacing means comprises a power charging plug removably connectable to the electronic device;
illuminating means for illuminating the interior compartment of the receptacle;
alarm means for producing an alarm upon triggering of the alarm means, the alarm means comprising an audible alarm apparatus that emits an audible sound upon triggering of the alarm apparatus, the alarm means further comprising a silent alarm apparatus that does not emit an audible sound when triggered, the alarm means comprising means for transmitting environmental sounds detected about the receptacle over a telecommunication device when the alarm means is triggered;
a microphone being mounted on the receptacle for detecting sound about the receptacle;
a display screen being mounted on the receptacle, the display screen being located on an exterior of the receptacle, the display screen being operably connected to the processing means, the display screen being operably connectable to the electronic device through the interfacing means;
an antenna being mounted on the receptacle, the antenna being operably couplable to the electronic device through the interfacing means;
a global positioning satellite (GPS) receiving system being mounted on the receptacle and being operably connected to the processing means;
telecommunication means mounted on the receptacle and being operably connected to the processing means;
a vibrator being mounted on the receptacle, the vibrator being operably connectable to the electronic device through the interfacing means such that the vibrator vibrates when a call is being received by the electronic device;
wherein the receptacle includes a carrying strap, the vibrator being located adjacent to the carrying strap; and
a charging base for inductively charging the rechargeable battery of the powering means when the receptacle is positioned adjacent to the charging base.
